(19) United States
(12) Patent Application Publication
(10) Pub. No.: US 2026/0161974 A1
(43) Pub. Date: Jun. 11, 2026

(54) MEMORY MANAGEMENT METHOD AND APPARATUS FOR INFERENCE SYSTEM

(71) Applicant: Alipay (Hangzhou) Digital Service Technology Co., Ltd., Hangzhou (CN)

(72) Inventors: Zhiqiang DING, Hangzhou (CN); Tongkai YANG, Hangzhou (CN); Jun DU, Hangzhou (CN)

(21) Appl. No.: 19/405,429

(22) Filed: Dec. 2, 2025

(30) Foreign Application Priority Data
Dec. 5, 2024 (CN) 202411783366.0

(51) Int. Cl. G06N 5/04; G06T 1/60

(52) U.S. Cl. CPC G06N 5/04; G06T 1/60

(57) ABSTRACT

One or more embodiments of this application provide a memory management method and apparatus for an inference system. The method includes: determining a memory management time window according to data processing duration associated with an inference request set being executed in the schedule queue; computing a GPU memory demand amount corresponding to the inference request set in the memory management time window, and allocating a GPU memory to the inference request set according to the GPU memory demand amount; and determining, when the memory management time window ends, a next memory management time window corresponding to the memory management time window again according to data processing duration associated with an inference request set being executed in the schedule queue.

### TECHNICAL FIELD

One or more embodiments of this application relate to the field of artificial intelligence technologies, and in particular, to a memory management method and apparatus for an inference system.

### BACKGROUND

An inference system is a computer program that draws a new conclusion or decision by using logic rules and known facts. The inference system is an important component in the field of artificial intelligence, and is mainly used for simulating a human decision-making process. The inference system deduces a conclusion based on a set of defined knowledge bases and an inference engine. The inference system may execute an inference request obtained by the inference system, and output a corresponding inference result.

A typical inference system usually includes the following parts: a knowledge base, an inference engine, a user interface, and an explanation facility. The knowledge base includes all facts and rules that a storage system knows. The facts may be about a state of the world, an object attribute, and the like, and the rules are logical expressions that describe how to draw a new conclusion from known facts. The inference engine is a core component of the inference system, and is responsible for performing logical operations in an inference process, that is, obtaining a new conclusion or decision from a given knowledge base. The inference engine deduces new knowledge by using a series of rules and known facts, to help the system resolve a problem or make a decision. The user interface allows a user to interact with the system, input a query, or observe a result of an inference process. The explanation facility is used to explain how the system draws a particular conclusion, which is very important for transparency and confidence levels.

The inference engine usually uses resources such as a computing resource, a storage resource, and a network resource (for example, a GPU, a GPU memory, a storage, and a network interface) to execute an inference task. Efficient utilization of these resources directly affects performance of the inference engine. Therefore, it is expected to better and more flexibly manage the resources used by the inference engine.

### SUMMARY

One or more embodiments of this application provide the following technical solutions:

This application provides a memory management method for an inference system, applied to an inference engine in the inference system, where a computing resource of the inference engine includes a GPU loaded on a computing device on which the inference engine is deployed; the inference engine maintains a schedule queue used to schedule an inference request set; and the method includes:
determining a memory management time window according to data processing duration associated with an inference request set being executed in the schedule queue;
computing a GPU memory demand amount corresponding to the inference request set in the memory management time window, and allocating a GPU memory to the inference request set according to the GPU memory demand amount; and
determining, when the memory management time window ends, a next memory management time window corresponding to the memory management time window again according to data processing duration associated with an inference request set being executed in the schedule queue.

This application further provides a memory management apparatus for an inference system, applied to an inference engine in the inference system, where a computing resource of the inference engine includes a GPU loaded on a computing device on which the inference engine is deployed; the inference engine maintains a schedule queue used to schedule an inference request set; and the apparatus includes:
a time window determining module, configured to determine a memory management time window according to data processing duration associated with an inference request set being executed in the schedule queue; and
a GPU memory allocation module, configured to: compute a GPU memory demand amount corresponding to the inference request set in the memory management time window, and allocate a GPU memory to the inference request set according to the GPU memory demand amount; and
the time window determining module is further configured to determine, when the memory management time window ends, a next memory management time window corresponding to the memory management time window again according to data processing duration associated with an inference request set being executed in the schedule queue.

This application further provides an electronic device, including:
a processor; and
a memory configured to store instructions executable by the processor;

The processor runs the executable instructions to implement the steps in the method according to any implementation described above.

This application further provides a computer-readable storage medium. The computer-readable storage medium stores computer instructions, and when the instructions are executed by a processor, the steps in the method according to any implementation described above are implemented.

In the foregoing technical solutions, the inference engine in the inference system may use the GPU loaded on the computing device on which the inference engine is located as a computing resource to execute an inference request and manage the GPU memory. Specifically, the inference engine may maintain a schedule queue used to schedule an inference request set, and determine a memory management time window according to data processing duration associated with an inference request set being executed in the schedule queue; subsequently, may compute a GPU memory demand amount corresponding to the inference request set in the memory management time window, and allocate a GPU memory to the inference request set according to the GPU memory demand amount; and after the memory management time window ends, may determine a next memory management time window corresponding to the memory management time window again according to data processing duration associated with an inference request set being executed in the schedule queue, so as to further perform GPU memory management in the next memory management time window.

By using the foregoing manner, a large amount of GPU memory does not need to be reserved for the inference engine when the inference engine is started. Instead, in a process in which the inference engine executes inference requests in batches, a memory management time window may be continuously set, and a GPU memory demand amount corresponding to an inference request set being executed in the memory management time window is predicted, to allocate a GPU memory to the inference request set according to the GPU memory demand amount. In this way, not only it can be ensured that a sufficient GPU memory can be used in the process in which the inference engine executes the inference requests in batches, but also a waste of GPU memory can be avoided.

### BRIEF DESCRIPTION OF THE DRAWINGS

The following describes the accompanying drawings to be used in the description of example embodiments, where:

FIG. 1 is a schematic diagram of an inference system according to an example embodiment of this application;

FIG. 2 is a schematic diagram of another inference system according to an example embodiment of this application;

FIG. 3 is a flowchart of a memory management method for an inference system according to an example embodiment of this application;

FIG. 4 is a schematic structural diagram of a device according to an example embodiment of this application; and

FIG. 5 is a block diagram of a memory management apparatus for an inference system according to an example embodiment of this application.

### DETAILED DESCRIPTION

Exemplary embodiments are described in detail herein, and examples of the exemplary embodiments are shown in the accompanying drawings. When the following description relates to the accompanying drawings, unless specified otherwise, the same numbers in different accompanying drawings represent the same or similar elements. Implementations described in the following example embodiments do not represent all implementations consistent with one or more embodiments in this application. In contrast, they are merely examples consistent with some aspects of one or more embodiments of this application.

It is worthwhile to note that, in other embodiments, steps of a corresponding method are not necessarily performed based on a sequence shown and described in this application. In some other embodiments, the method can include more or fewer steps than that described in this application. In addition, a single step described in this application may be split into a plurality of steps in other embodiments for description; and a plurality of steps described in this application may be combined into a single step in other embodiments for description.

In this application, an inference engine in an inference system may be deployed on a computing device, and uses a computing resource, a storage resource, a network resource, or the like (for example, a GPU, a GPU memory, a storage, or a network interface) of the computing device to perform computing in an inference process, to execute an inference task. Alternatively, the inference engine in the inference system may be deployed on a computing cluster, to meet demands of processing large-scale data, a high concurrency request, or high-performance computing, thereby implementing a higher computing capability, better fault tolerance, and more flexible resource management.

Generally, the inference engine may use a CPU as a computing resource, where the CPU may be a CPU loaded on a computing device on which the inference engine is deployed.

With the development of artificial intelligence technologies, an inference system based on a large model (for example, a Large Language Model) is more widely applied.

The large model refers to a machine learning model having a large quantity of parameters, for example, various variants under a Transformer architecture, including but not limited to a natural language processing model such as GPT and BERT. These models achieve a strong representation learning capability by using a large amount of training data and a complex architecture.

In an inference system based on a large model, the large model may be considered as a huge knowledge base, which includes information learned from a large amount of data. The large model learns a large quantity of patterns and features in a training process, and these patterns and features represent a complex relationship in data. Therefore, to some extent, information stored in the large model may be considered as a knowledge form.

An inference engine designed for the large model is responsible for invoking the large model to perform specific inference work, that is, can manage loading of the large model, perform an inference operation of the large model, and manage interaction with hardware (such as a CPU, a GPU, or another accelerator). The inference engine may further include an optimization algorithm, to increase an inference speed and improve inference efficiency.

In an actual application, the large model may be deployed separately from the inference system, or the large model may be integrated into the inference system, and the inference engine in the large model is used to invoke the large model to efficiently execute an inference task.

Because the large model is an artificial intelligence application that needs a large quantity of computing resources, when invoking the large model to execute an inference task, the inference engine usually uses a GPU as a computing resource.

The GPU is specifically designed for parallel processing, and can process a plurality of data points simultaneously. This is especially useful for deep learning models, because the deep learning models usually need to perform a same operation on a large amount of data. Modern AI models, especially neural network models, need a large quantity of floating point operations. Performance of the GPU on floating point operations is generally better than that of the CPU, and especially when the GPU processes large-scale matrix operations, which are common operations in deep learning. The GPU usually has a higher memory bandwidth than the CPU, which means that the GPU can read data from and write data into a memory more quickly. This is very important for an application that needs to frequently access a large amount of data. Many GPU vendors (for example, NVIDIA) optimize their hardware and software stacks for machine learning tasks. For example, they provide hardware specially used for accelerating a tensor operation, and a programming model such as CUDA to take full advantage of these hardware features. The GPU can increase an inference speed. For an application program deployed on a large scale, using a GPU can reduce a delay and increase a response speed of a system.

In a running process of the inference engine, whether resources such as a computing resource, a storage resource, and a network resource of a computing device can be efficiently used usually directly affects performance of the inference engine.

For example, in the inference process of the large model, a KV cache (Key-Value Cache) is usually used to store a generated token.

It should be noted that the inference process of the large model is a process of generating a corresponding output result (that is, an inference result) according to given input data (that is, data included in an inference request) by using a trained large machine learning model. In the field of natural language processing, especially in a large language model, an inference process usually involves generating a continuous text sequence according to a given input prompt, and generating one token each time of iteration. The token herein generally refers to a series of small units, such as words or characters, into which a text is segmented during natural language processing, and specifically depends on a word segmentation manner of a model.

Specifically, a segment of text may be provided to the model as an input, and the segment of text is referred to as a prompt. The model receives the prompt, and converts the prompt into a form that can be processed internally. Usually, each token in the prompt is converted into a corresponding numerical representation, for example, an embedding vector. The embedding vector is a value vector in a high-dimensional space, and is used to represent semantic information of each token. Based on the current prompt, the model predicts a next most possible token through complex computing (for example, a multilayer neural network operation). The model adds the predicted token behind an existing prompt, to form a new prompt. The foregoing steps may be repeated for a plurality of times. Each repetition is referred to as one iteration. In each iteration, the model predicts a next token based on a latest prompt, until a set stop condition is reached, for example, a specific quantity of tokens are generated or a particular stop flag is encountered.

The KV cache is a data storage manner, and is usually used for accelerating data access. It is a form of storing data as a key-value pair, where the key is a unique identifier used for searching for data, and the value is associated data or information pointing to a data position. When an application program requests specific data, a system may quickly retrieve a corresponding value by using a key, thereby increasing a response speed of the system.

In a large model, especially in a large model used for executing a natural language processing task, the KV cache is used for storing a previous computing result, so as to be quickly and repeatedly used in a decoding process, thereby accelerating an inference process.

In an actual application, a large amount of GPU memory needs to be consumed when the KV cache is used to store a generated token. For an inference engine based on a large model, when the inference engine is started, a specific amount of GPU memory needs to be reserved for the inference engine based on past experience and an actual situation, to be used for subsequent model inference in the inference engine. An allocation proportion is usually 80% to 90% of a total amount of GPU memory. In addition, because intermediate data generated in the inference process of the large model has uncertainty, a specific amount of GPU memory further needs to be reserved for the intermediate data.

However, traffic of the inference engine is not fixed, that is, a quantity of inference tasks that need to be executed by the inference engine may change with time. For example, in a current time period, many inference requests are sent to the inference engine, and in a next time period, a few inference requests are sent to the inference engine. In this case, the GPU memory reserved for the inference engine is idle when traffic is low, and cannot be used by another service. In addition, 10% to 20% of the remaining GPU memory that is not reserved for the inference engine cannot be used by the inference engine. Therefore, the GPU memory of the computing device on which the inference engine is deployed cannot be efficiently used, which affects performance of the inference engine.

In the technical solutions provided by one or more embodiments of this application, the inference engine in the inference system may use the GPU loaded on the computing device on which the inference engine is located as a computing resource to execute an inference request and manage the GPU memory. Specifically, the inference engine may maintain a schedule queue used to schedule an inference request set, and determine a memory management time window according to data processing duration associated with an inference request set being executed in the schedule queue; subsequently, may compute a GPU memory demand amount corresponding to the inference request set in the memory management time window, and allocate a GPU memory to the inference request set according to the GPU memory demand amount; and after the memory management time window ends, may determine a next memory management time window corresponding to the memory management time window again according to data processing duration associated with an inference request set being executed in the schedule queue, so as to further perform GPU memory management in the next memory management time window.

By using the foregoing manner, a large amount of GPU memory does not need to be reserved for the inference engine when the inference engine is started. Instead, in a process in which the inference engine executes inference requests in batches, a memory management time window may be continuously set, and a GPU memory demand amount corresponding to an inference request set being executed in the memory management time window is predicted, to allocate a GPU memory to the inference request set according to the GPU memory demand amount. In this way, not only it can be ensured that a sufficient GPU memory can be used in the process in which the inference engine executes the inference requests in batches, but also a waste of GPU memory can be avoided.

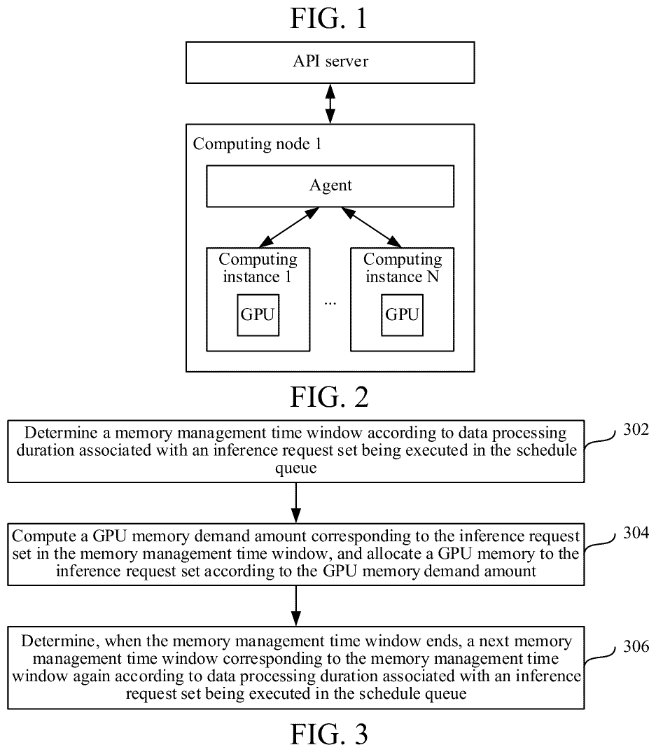

Referring to FIG. 1 and FIG. 2, FIG. 1 and FIG. 2 are respectively schematic diagrams of an inference system according to an example embodiment of this application.

As shown in FIG. 1, the inference system may include an API server and an inference engine.

The API server is a server specifically designed to process a client request and return a response, and is usually an indispensable component in an application program. It is responsible for processing a client request, executing service logic, generating a response, and ensuring security, scalability, and performance of a system.

Specifically, the API server is usually used as a unified entrance of the inference system, to process all requests from a client, and may distribute the requests to different backend services, to implement decoupling between services. The API server may be responsible for identity verification and authorization, ensure that only an authorized request can access a system resource, and implement fine-grained permission control, to protect sensitive data and operations. The API server may further cooperate with a load balancer, to evenly distribute the requests to a plurality of backend instances, thereby improving availability and performance of the inference system.

The inference engine may be deployed on an independent computing device, or may be deployed on a computing cluster including at least one computing node. The computing device may be a physical or virtual local computing device, or may be a physical or virtual cloud computing device.

The computing cluster is a system in which at least one computing device works together through a network. These computing devices jointly complete a computing task, and provide a stronger computing capability and higher availability than a single computing device. The computing node is one of core components in a computing cluster, and generally refers to a computing device configured to execute a computing task, and a GPU loaded thereon may be used as a computing resource.

Correspondingly, the API server may be deployed on a computing device on which the inference engine is located. Alternatively, the API server may be deployed on a head node in the computing cluster, where the head node generally refers to a computing node responsible for management and scheduling of the computing cluster; or may be deployed on another computing device outside the computing cluster.

As shown in FIG. 2, for an independent computing device or each computing device in a computing cluster on which the inference engine is deployed, at least one computing instance may be deployed on the computing device. The computing instance refers to a dedicated resource that is allocated on demand by using a virtualization technology in a local data center or a cloud computing platform. Resources of the computing instances may include a computing resource, a storage resource, a network resource, and the like (for example, a GPU, a GPU memory, a storage, and a network interface), so that each computing instance can execute a particular computing task by using the resources. The computing instance may be created, started, stopped, or deleted according to an actual need, and a resource thereof may also be adjusted according to a need.

The computing resource of the computing instance may be a GPU of a computing device on which the computing instance is located. Specifically, one computing device may be loaded with a plurality of GPUs, and one GPU may be allocated to one computing instance as a computing resource of the computing instance. Alternatively, one computing device may be loaded with only one GPU, and a computing resource allocated to one computing instance may be a part of a computing unit, a memory, and the like of the GPU.

In an inference engine based on a large model, each computing instance may invoke the large model to perform specific inference work, that is, the large model may be loaded to each computing instance, and each computing instance performs an inference operation of the large model. Specifically, the large model may be read from a local or cloud storage medium (for example, a local magnetic disk or a cloud storage) to a GPU memory of each computing stance, to perform inference on a GPU resource of each computing instance based on the large model.

In an actual application, a model runtime framework may be installed in the computing instance, and after the large model is read into the computing instance, a model service is configured according to the model runtime framework and the large model, so that the computing instance can be used as a model service instance that can run independently. The model runtime refers to an environment and a framework for executing model inference after the model is deployed. The environment usually includes a series of steps such as model loading, input data processing, model execution, and output result processing, and covers an entire life cycle from loading to execution to unloading of the model.

For the inference engine that includes at least one computing instance, the inference request may be scheduled on the inference engine in a manner of load-aware scheduling.

Load-aware scheduling is a policy for allocating a task according to a current load condition of each node or resource in a computing system. This scheduling manner aims to optimize resource use efficiency, reduce waiting time and a processing delay, and improve overall throughput of a system.

Load-aware scheduling is usually applied to scenarios such as a distributed system, a cloud computing platform, and a data center, and an objective of the load-aware scheduling is to dynamically balance workloads of nodes, to avoid occurrence of overload of some nodes and idleness of other nodes. By monitoring a load condition of each node in real time, a load-aware scheduler may make a more proper task allocation decision.

For example, in the inference system, the API server may communicate with the inference engine. In this case, the API server may obtain the inference request from the request queue, select, according to a load condition of a GPU of each computing instance, a computing instance having a proper load condition of the GPU, and schedule the obtained inference request to the computing instance, to execute the inference request by using a GPU resource of the computing instance.

By deploying the computing instance on the computing device, first, a resource of the computing device can be fully used to accelerate execution of a computing task, thereby improving a computing capability of the inference engine. Second, different computing instances are independent of each other, so that stability and security of the computing task can be ensured, and resource isolation and management can be implemented, thereby facilitating effective resource utilization and avoiding resource expropriation. Third, for computing tasks that need to be processed in parallel, completion time of the computing task may be accelerated by means of parallel computing. Fourth, elastic stretching may be implemented. When a large quantity of computing tasks need to be processed, computing instances may be added, and when a quantity of computing tasks that need to be processed decreases, some computing instances may be terminated, to release some resources, thereby implementing flexible resource allocation.

For the API server, the API server may include two components, which are respectively a request router component responsible for routing the inference request to forward the inference request to the inference engine, and a monitor component responsible for monitoring operation-related information (for example, GPU memory utilization, GPU memory bandwidth utilization, a quantity of waiting inference requests in a schedule queue, and a quantity of running inference requests) of all computing instances in the inference engine.

For the computing device used for deploying the inference engine, to facilitate maintenance, management, and scheduling of the computing instance deployed on the computing device, an agent may further be deployed on the computing device.

The API server may communicate with the agent deployed on the computing device. In this case, the API server may obtain the inference request from the request queue, select, according to a load condition of a GPU of each computing instance, a computing instance having a proper load condition of the GPU, and send the obtained inference request to an agent deployed on the computing device on which the computing instance is located. The agent further schedules the inference request to the computing instance, to execute the inference request by using a GPU resource of the computing instance.

In an actual application, to ensure reliability and correctness of inference request scheduling, the agent may maintain a schedule queue.

The schedule queue is a special type of task queue, and is mainly used for managing and scheduling a task (that is, an inference task specified by an inference request in this application) with particular execution time or priority. Main functions of the schedule queue include task scheduling, task management, and resource optimization. Task scheduling means that the schedule queue can ensure that a task is executed at a specified time point or within a specified time range, and supports scheduling of a periodic task. In addition, a priority of a task may be set, to ensure that a task with a high priority in the schedule queue is executed preferably. Task management refers to gathering all tasks in one queue for management for ease of monitoring and control, and an execution status of a task may be tracked, including states such as unexecuted, being executed, completed, and failed. Resource optimization means that execution time of a task is properly scheduled, so that a system can be prevented from being excessively loaded at a moment, and system resources can be ensured to be effectively used, thereby avoiding resource waste.

Through the schedule queue and the computing instance, the agent has a queue and batch processing capability. That is, each inference request in an inference request set (also referred to as a batch of inference requests) may be scheduled to each computing instance by using the schedule queue, so that each computing instance executes each inference request. In this way, different inference requests in the inference request set can be executed in parallel.

In addition, the agent may further include two components, which are respectively a memory predictor and a dynamic memory manager. The memory predictor may continuously execute a memory consumption prediction algorithm, and dynamically manage a GPU memory in combination with the dynamic memory manager.

For each computing instance, the computing instance may include two components, respectively, a KV cache component configured to cache intermediate data and a result of inference and avoid repeated computing, and an executor component responsible for invoking a large model to execute an inference task corresponding to an inference request.

Based on FIG. 1 and FIG. 2, referring to FIG. 3, FIG. 3 is a flowchart of a memory management method for an inference system according to an example embodiment of this application.

In this embodiment, the memory management method for an inference system may be applied to the inference engine shown in FIG. 1.

As shown in FIG. 3, the memory management method for an inference system may include the following steps:

Step 302: Determine a memory management time window according to data processing duration associated with an inference request set being executed in the schedule queue.

In this embodiment, after each inference request in an inference request set is scheduled to each computing instance by using the schedule queue for execution, an execution status of each inference request in the inference request set maintained by the schedule queue may be updated from an “unexecuted state” to a “being executed state”. For an inference request set being executed in the schedule queue, a memory management time window may be determined according to data processing duration associated with the inference request set. Subsequently, the memory management time window may be used as a time unit of a GPU memory management task, that is, GPU memory management is executed once in the memory management time window.

In some embodiments, to improve accuracy and adaptability of the determined memory management time window, when the memory management time window is determined according to the data processing duration associated with the inference request set being executed in the schedule queue, corresponding data processing duration may be first determined according to an execution stage of each inference request in the inference request set, and then the memory management time window is determined according to the data processing duration.

It should be noted that the inference process may include a plurality of stages in some cases. For example, for an inference system based on a large model, an inference process of the large model (especially, a generative model in natural language processing) may include a prefill stage and a decode stage.

In the inference process of the large model, the prefill stage and the decode stage refer to different steps in text generation.

The prefill stage usually occurs at an initial stage of text generation, and a main objective of the prefill stage is to provide an initial context for the model, so that the model can better understand and generate a subsequent text. At the prefill stage, the model usually generates an initial text segment, and the text segment includes a starting part of a generation sequence. This stage may involve selecting a most proper starting word or phrase by using some pre-defined policies or algorithms. For example, when a condition generation task is processed, the model may first generate a part of text based on an input condition (for example, abstract generation, question and answering, or dialog).

The decode stage is a main stage of text generation. The model gradually generates new words or characters at this stage until a complete output sequence is generated. At the decode stage, the model generates new content word by word or phrase by phrase based on an existing text. In each iteration, the model predicts a next most possible word, and adds it into a current text sequence. This process is continued until a preset end condition is reached (for example, a maximum text length is reached, or a text end flag is generated). Various policies may be used at the decode stage to optimize generation quality, for example, technologies such as Top-k sampling and Top-p (also referred to as Nucleus sampling) sampling. These technologies may help the model to avoid generation of excessively trivial or meaningless content.

In an actual application, the prefill stage and the decode stage are closely connected. The prefill stage provides an initial text basis, and the decode stage is responsible for gradual expansion based on the prefill stage, to generate a complete text output. The two stages jointly determine quality and continuity of a finally generated text.

Specifically, whether there is an inference request at the prefill stage may be first determined in the inference request set being executed in the schedule queue.

If there is an inference request at the prefill stage, quantities of tokens included in the inference requests in the inference request set may be compared, to determine a maximum quantity, that is, a maximum token quantity corresponding to the inference requests in the inference request set, so that token processing duration corresponding to the maximum token quantity may be determined as a length of the memory management time window.

If no inference request at the prefill stage exists, it indicates that all the inference requests in the inference request set are at the decode stage. In this case, token generation duration corresponding to the inference requests in the inference request set may be compared. The token generation duration is duration in which one token is generated based on a prompt included in the inference request, to determine longest token generation duration corresponding to the inference requests in the inference request set, so that the longest token generation duration may be determined as the length of the memory management time window.

Step 304: Compute a GPU memory demand amount corresponding to the inference request set in the memory management time window, and allocate a GPU memory to the inference request set according to the GPU memory demand amount.

In this embodiment, when the memory time window is determined, the GPU memory demand amount corresponding to the inference request set in the memory management time window may be computed, so that the GPU memory can be allocated to the inference request set based on the GPU memory demand amount. In this way, because the GPU memory may be allocated to the inference engine based on an actual GPU memory demand amount in a process in which the inference engine executes the inference request in the inference request set, not only it can be ensured that a sufficient GPU memory can be used in the process in which the inference engine executes the inference request, but also a waste of GPU memory can be avoided.

In an actual application, the memory predictor may execute a memory consumption prediction algorithm, that is, determine a memory management time window according to data processing duration associated with an inference request set being executed in the schedule queue, and compute a GPU memory demand amount corresponding to the inference request set in the memory management time window. The dynamic memory manager executes specific GPU memory allocation, that is, allocates the GPU memory to the inference request set according to the GPU memory demand amount.

Step 306: Determine, when the memory management time window ends, a next memory management time window corresponding to the memory management time window again according to data processing duration associated with an inference request set being executed in the schedule queue.

In this embodiment, after execution of the GPU memory management in the memory management time window ends, the memory management time window may be waited to end.

When the memory management time window ends, a next memory management time window corresponding to the memory management time window may be determined again according to data processing duration associated with an inference request set being executed in the schedule queue.

Specifically, assuming that the memory management time window is a T^{th} memory management time window determined according to data processing duration associated with an inference request set being executed in the schedule queue, a GPU memory demand amount corresponding to the inference request set in the T^{th} memory management time window may be computed, and the GPU memory is allocated to the inference request set according to the GPU memory demand amount. When the T^{th} memory management time window ends, a (T+1)^{th} memory management time window may be determined again according to data processing duration associated with an inference request set being executed in the schedule queue, to compute a GPU memory demand amount corresponding to the inference request set in the (T+1)^{th} memory management time window, and the GPU memory is allocated to the inference request set according to the GPU memory demand amount. The rest can be deduced by analogy.

In some embodiments, when the GPU memory demand amount corresponding to the inference request set in the memory management time window is computed, specifically, static GPU memory usage corresponding to the inference request set in the memory management time window may be computed first, then maximum GPU memory usage in a previous memory management time window corresponding to the memory management time window and a sum of static GPU memory usage corresponding to the inference request set in target memory management time windows are determined, and a difference between the maximum GPU memory usage and the sum of the static GPU memory usage is determined as dynamic GPU memory usage corresponding to the inference request set in the memory management time window. The target memory management window is a memory management window located before the memory management time window in an execution process of the inference request set. Finally, a sum of the static GPU memory usage and the dynamic GPU memory usage is determined as the GPU memory demand amount corresponding to the inference request set in the memory management time window.

Specifically, assuming that the memory management time window is a T^{th} memory management time window determined according to data processing duration associated with an inference request set being executed in the schedule queue, a previous memory management time window corresponding to the T^{th} memory management time window is a (T−1)^{th} memory management time window, and target memory management windows located before the T^{th} memory management time window in an execution process of the inference request set are the first to (T−1)^{th} memory management time windows. In this case, if StaticResource[T] represents static GPU memory usage in the T^{th} memory management time window, DynamicResource[T] represents dynamic GPU memory usage in the T^{th} memory management time window, MaxResource[T] represents maximum GPU memory usage in the T^{th} memory management time window, and NeedResource[T] represents the GPU memory demand amount in the T^{th} memory management time window, there is the following formula:

$$DynamicResource [ T ] = MaxResource [ T - 1 ] - ( StaticResource [ 0 ] + StaticResource [ 1 ] + … + StaticResource [ T - 1 ] ) ;$$

$$NeedResource [ T ] = StaticResource [ T ] + DynamicResource [ T ] .$$

That is, for the current memory management time window, the dynamic GPU memory usage in the memory management time window may be predicted according to maximum GPU memory usage in a previous memory management time window corresponding to the memory management time window and a sum of static GPU memory usage in all memory management time windows before the memory management time window.

It should be noted that the static GPU memory usage refers to a GPU memory that can be predicted to be used in an inference process, for example, GPU memory usage needed by a token included in a prompt, or GPU memory usage needed by a new token generated based on a prompt. The dynamic GPU memory usage refers to a GPU memory that cannot be predicted to be used in an inference process, for example, GPU memory usage needed by intermediate data with uncertainty generated in an inference process of a large model.

In an actual application, to improve compatibility of the technical solutions in this application, when the inference engine is started, a sufficient amount of virtual GPU memory may be reserved for the inference engine. In a subsequent inference process, the memory management method is used, and a physical GPU memory is allocated by invoking an API provided by a compute unified device architecture (CUDA).

In some embodiments, to improve accuracy and adaptability of the determined static GPU memory usage, when the static GPU memory usage corresponding to the inference request set in the memory management time window is computed, the static GPU memory usage in the memory management time window may be determined according to an execution stage of each inference request in the inference request set.

Specifically, whether there is an inference request at the prefill stage may be first determined in an inference request set being executed in the schedule queue.

If there is an inference request at the prefill stage, GPU memory usage (which may be referred to as first GPU memory usage) needed by a token corresponding to each inference request in the inference request set may be determined, GPU memory usage (which may be referred to as second GPU memory usage) needed by one token may be generated based on each inference request in the inference request set, and a sum of the first GPU memory usage and the second GPU memory usage may be determined as the static GPU memory usage corresponding to the inference request set in the memory management time window. GPU memory usage needed by a token corresponding to an inference request may be GPU memory usage needed by a token included in a prompt in the inference request. Generating GPU memory usage needed by a token based on an inference request may be generating GPU memory usage needed by a token based on a prompt included in the inference request.

If no inference request at the prefill stage exists, it indicates that all the inference requests in the inference request set are at the decode stage. In this case, GPU memory usage needed by one token may be generated based on each inference request in the inference request set, and the GPU memory usage may be determined as the static GPU memory usage corresponding to the inference request set in the memory management time window.

In some embodiments, to ensure properness and availability of GPU memory allocation, when the GPU memory is allocated to the inference request set based on the GPU memory demand amount, specifically current GPU memory usage corresponding to the inference request set may be obtained first. Then, whether the GPU memory allocation condition and the GPU memory release condition are met may be determined according to the current GPU memory usage and the GPU memory demand amount.

It should be noted that the GPU memory allocation condition and the GPU memory release condition are two mutually exclusive conditions. That is, if the GPU memory allocation condition is met, it means that the GPU memory release condition is not met. If the GPU release allocation condition is met, it indicates that the GPU memory allocation condition is not met.

If the GPU memory allocation condition is met, the GPU memory may be allocated to the inference request set according to the GPU memory demand amount.

If the GPU memory release condition is met, the GPU memory used to execute the inference request set may be released, and the current CPU memory usage may be updated, to allocate a GPU memory to the inference request set according to the GPU memory demand amount if it is determined that the GPU memory allocation condition is met according to the updated current GPU memory usage and the GPU memory demand amount.

It should be noted that the released GPU memory usage may be determined according to an executed GPU memory release task, and the released GPU memory usage is subtracted based on the current GPU memory usage, to obtain the updated current GPU memory usage. However, in an actual application, to obtain more accurate current GPU memory usage, the current GPU memory usage may be obtained in real time or periodically by using a tool such as a data center GPU manager (DCGM). The DCGM is a tool used for managing and monitoring resources of GPUs in a data center, and can help effectively manage a large-scale GPU cluster, to provide deep insight on performance, health conditions, and utilization of GPUs.

In some embodiments, the memory allocation condition may be that a sum of current GPU memory usage and a GPU memory demand amount is less than a preset threshold (which may be referred to as a first threshold). The GPU memory release condition may be that current GPU memory usage is greater than a preset threshold (which may be referred to as a second threshold). Specific values of the first threshold and the second threshold may be the same or may be different. This is not specifically limited in this application.

Specifically, NeedResource[T] represents a GPU memory demand amount in a T^{th} memory management time window, CurrentResource[T] represents current GPU memory usage obtained when GPU memory management is performed in the T^{th} memory management time window, Threshold1 represents the first threshold, and Threshold2 represents the second threshold. Therefore, it may be determined that the memory allocation condition is met when CurrentResource[T]+NeedResource[T]<Threshold1, and it is determined that the memory release condition is met when CurrentResource[T]>Threshold2.

In an actual application, a period of time in which CurrentResource[T]+NeedResource[T]>Threshold1 and CurrentResource[T]<Threshold2 may be used as buffer time for releasing the GPU memory. If CurrentResource[T] changes within this period of time, so that the updated CurrentResource[T]+NeedResource[T]<Threshold1, because the memory allocation condition is met, the GPU memory may be allocated to the inference request set according to the GPU memory demand amount. If CurrentResource[T] changes within this period of time, so that CurrentResource[T]>Threshold2, because the memory release condition is met, the GPU memory used to execute the inference request set may be released. In this way, a quantity of times of executing a GPU memory release task can be reduced to some extent.

In some embodiments, a plurality of manners may be used to release the GPU memory. For example, when the GPU memory used to execute the inference request set is released, a specific GPU memory release manner may be selected according to a quantity of inference requests in the inference request set.

Specifically, whether the quantity of inference requests in the inference request set is greater than a preset threshold (which may be referred to as a third threshold) may be determined first.

If the quantity of inference requests in the inference request set is greater than the third threshold, a token corresponding to each inference request in the inference request set may be offloaded from the GPU memory to the CPU memory, to release the GPU memory occupied by the token.

If the quantity of inference requests in the inference request set is not greater than the third threshold, each inference request may be updated based on a token corresponding to the inference request in the inference request set, to release the GPU memory occupied by the token. An inference request is updated based on a token corresponding to the inference request, that is, a prompt is updated by using a token generated based on the prompt included in the inference request, to form a new prompt.

In the foregoing technical solutions, the inference engine in the inference system may use the GPU loaded on the computing device on which the inference engine is located as a computing resource to execute an inference request and manage the GPU memory. Specifically, the inference engine may maintain a schedule queue used to schedule an inference request set, and determine a memory management time window according to data processing duration associated with an inference request set being executed in the schedule queue; subsequently, may compute a GPU memory demand amount corresponding to the inference request set in the memory management time window, and allocate a GPU memory to the inference request set according to the GPU memory demand amount; and after the memory management time window ends, may determine a next memory management time window corresponding to the memory management time window again according to data processing duration associated with an inference request set being executed in the schedule queue, so as to further perform GPU memory management in the next memory management time window.

By using the foregoing manner, a large amount of GPU memory does not need to be reserved for the inference engine when the inference engine is started. Instead, in a process in which the inference engine executes inference requests in batches, a memory management time window may be continuously set, and a GPU memory demand amount corresponding to an inference request set being executed in the memory management time window is predicted, to allocate a GPU memory to the inference request set according to the GPU memory demand amount. In this way, not only it can be ensured that a sufficient GPU memory can be used in the process in which the inference engine executes the inference requests in batches, but also a waste of GPU memory can be avoided.

Corresponding to the above-mentioned method embodiments, this application further provides an apparatus embodiment.

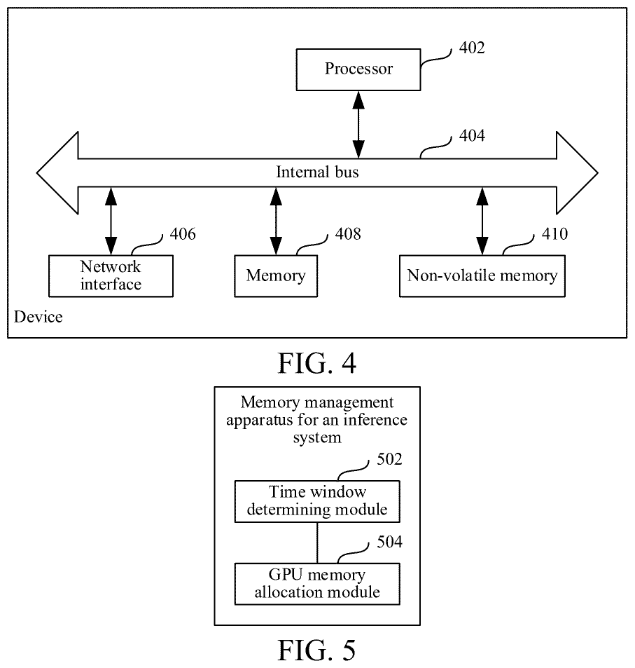

Referring to FIG. 4, FIG. 4 is a schematic structural diagram of a device according to an example embodiment of this application. In terms of hardware, the device includes a processor 402, an internal bus 404, a network interface 406, an internal memory 408, and a non-volatile memory 410, and certainly may further include other needed hardware. One or more embodiments of this application can be implemented in a software-based way, for example, the processor 402 reads a corresponding computer program from the non-volatile memory 410 to the internal memory 408, and then runs the computer program. Certainly, in addition to a software implementation, one or more embodiments of this application do not rule out other implementations, such as an implementation of a logic device or a combination of software and hardware. In other words, an execution body of the following processing procedure is not limited to each logical module, and can be hardware or a logic device.

Referring to FIG. 5, FIG. 5 is a block diagram of a memory management apparatus for an inference system according to an example embodiment of this application.

The memory management apparatus for an inference system may be applied to the device shown in FIG. 4, so as to implement the technical solutions of this application. An inference engine in the inference system may be deployed on the device, and the memory management apparatus for the inference system may be specifically applied to the inference engine. A computing resource of the inference engine includes a GPU loaded on a computing device on which the inference engine is deployed; the inference engine maintains a schedule queue used to schedule an inference request set; and the apparatus includes:
a time window determining module 502, configured to determine a memory management time window according to data processing duration associated with an inference request set being executed in the schedule queue; and
a GPU memory allocation module 504, configured to: compute a GPU memory demand amount corresponding to the inference request set in the memory management time window, and allocate a GPU memory to the inference request set according to the GPU memory demand amount; and
the time window determining module 502 is further configured to determine, when the memory management time window ends, a next memory management time window corresponding to the memory management time window again according to data processing duration associated with an inference request set being executed in the schedule queue.

In some embodiments, the determining a memory management time window according to data processing duration associated with an inference request set being executed in the schedule queue includes:
determining whether there is an inference request at a prefill stage in the inference request set being executed in the schedule queue; and
if there is an inference request at the prefill stage, determining a maximum token quantity corresponding to the inference request in the inference request set, and determining the memory management time window according to token processing duration corresponding to the maximum token quantity; or
if no inference request at the prefill stage exists, determining longest token generation duration corresponding to an inference request in the inference request set, and determining the memory management time window according to the longest token generation duration.

In some embodiments, the computing a GPU memory demand amount corresponding to the inference request set in the memory management time window includes:
computing static GPU memory usage corresponding to the inference request set in the memory management time window;
determining maximum GPU memory usage in a previous memory management time window corresponding to the memory management time window and a sum of static GPU memory usage corresponding to the inference request set in each target memory management time window, and determining a difference between the maximum GPU memory usage and the sum of the static GPU memory usage as dynamic GPU memory usage corresponding to the inference request set in the memory management time window, where the target memory management window is a memory management window located before the memory management time window in a process of executing the inference request set; and
determining a sum of the static GPU memory usage and the dynamic GPU memory usage as the GPU memory demand amount corresponding to the inference request set in the memory management time window.

In some embodiments, the computing static GPU memory usage corresponding to the inference request set in the memory management time window includes:
determining whether there is an inference request at a prefill stage in the inference request set being executed in the schedule queue; and
if there is an inference request at the prefill stage, determining first GPU memory usage needed by a token corresponding to each inference request in the inference request set, generating, based on each inference request in the inference request set, second GPU memory usage needed by one token, and determining a sum of the first GPU memory usage and the second GPU memory usage as the static GPU memory usage corresponding to the inference request set in the memory management time window; or
if no inference request at the prefill stage exists, generating GPU memory usage needed by one token based on each inference request in the inference request set, and determining the GPU memory usage as the static GPU memory usage corresponding to the inference request set in the memory management time window.

In some embodiments, the allocating a GPU memory to the inference request set according to the GPU memory demand amount includes:
obtaining current GPU memory usage corresponding to the inference request set;
determining, according to the current GPU memory usage and the GPU memory demand amount, whether a GPU memory allocation condition and a GPU memory release condition are met;
allocating a GPU memory to the inference request set according to the GPU memory demand amount if the GPU memory allocation condition is met; and
if the GPU memory release condition is met, releasing a GPU memory used to execute the inference request set, and updating the current CPU memory usage, to allocate a GPU memory to the inference request set according to the GPU memory demand amount if it is determined that the GPU memory allocation condition is met according to the updated current GPU memory usage and the GPU memory demand amount.

In some embodiments, the GPU memory allocation condition includes:
a sum of the current GPU memory usage and the GPU memory demand amount is less than a preset first threshold; and
the GPU memory release condition includes:
the current GPU memory usage is greater than a preset second threshold.

In some embodiments, the releasing a GPU memory used to execute the inference request set includes:
determining whether a quantity of inference requests in the inference request set is greater than a preset third threshold; and
if the quantity is greater than the third threshold, offloading a token corresponding to each inference request in the inference request set to a CPU memory, to release a GPU memory occupied by the token; or if the quantity is not greater than the third threshold, updating the inference request based on the token corresponding to each inference request in the inference request set, to release a GPU memory occupied by the token.

The apparatus embodiments basically correspond to the method embodiments. Therefore, for related parts, references can be made to partial descriptions in the method embodiments. The previously described apparatus implementation is merely an example. The modules described as separate parts may or may not be physically separate, and parts displayed as modules may or may not be physical modules, may be located in one position, or may be distributed on a plurality of network modules. Some or all of the modules or units can be selected based on actual needs to achieve the objectives of the technical solutions in this application.

The system, apparatus, module, or unit illustrated in the previous embodiments can be implemented by using a computer chip or an entity, or can be implemented by using a product having a certain function. A typical implementation device is a computer. A specific form of the computer may be a personal computer, a laptop computer, a cellular phone, a camera phone, a smartphone, a personal digital assistant, a media player, a navigation device, an email transceiver device, a game console, a tablet computer, a wearable device or a combination of any devices of these devices.

In a typical configuration, the computer includes one or more central processing units (CPU), an input/output interface, a network interface, and an internal memory.

The memory can include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a disk memory, a quantum memory, a graphene-based storage medium, another magnetic storage device, or any other non-transmission medium. The computer storage medium can be configured to store information that can be accessed by a computing device. According to limitations of this specification, the computer-readable medium does not include transitory computer-readable media, such as a modulated data signal and a modulated carrier.

It should also be noted that the terms “include”, “comprise” and any other variants mean to cover the non-exclusive inclusion, so that the process, method, article, or device which include a series of elements not only include those elements, but also include other elements which are not clearly listed, or include inherent elements of the process, method, article, or device. Unless otherwise specified, an element limited by “include a/an . . . ” does not exclude other same elements existing in the process, the method, the article, or the device that includes the element.

Specific embodiments of this application are described above. Other embodiments fall within the scope of this specification. In some cases, actions or steps described in the application can be performed in a sequence different from that in the embodiments and desired results can still be achieved. In addition, the processes depicted in the accompanying drawings is not necessarily performed in the specific order or successively to achieve an expected result. In some implementations, multitasking and parallel processing may be feasible or beneficial.

Terms used in one or more embodiments of this application are merely used to describe specific embodiments, and are not intended to limit the one or more embodiments of this application. The terms “a” and “the” of singular forms are also intended to include plural forms, unless otherwise specified in the context clearly. The term “and/or” indicates and includes any or all possible combinations of one or more associated listed items.

Descriptions of the terms “one embodiment”, “some embodiments”, “example”, “specific example”, or “one implementation” used in one or more embodiments of this application mean that a specific feature or characteristic described with reference to this embodiment is included in at least one embodiment of this application. A schematic description of these terms is not necessarily with respect to the same embodiment. In addition, the described specific feature or characteristic can be combined in a proper way in one or more embodiments of this application. In addition, without contradicting each other, different embodiments and specific features or characteristics in the different embodiments can be combined.

It should be understood that although terms “first”, “second”, “third”, etc. may be used in one or more embodiments of this application to describe various types of information, the information is not limited to these terms. These terms are merely used to distinguish between information of the same type. For example, without departing from the scope of one or more embodiments of this application, first information can also be referred to as second information, and similarly, the second information can be referred to as the first information. Depending on the context, for example, the word “if” used here can be explained as “while”, “when”, or “in response to determining”.

The above-mentioned descriptions are merely preferred embodiments in one or more embodiments of this application, but are not intended to limit the one or more embodiments of this application. Any modification, equivalent replacement, improvement, etc. made without departing from the spirit and principle of the one or more embodiments of this application shall fall within the protection scope of the one or more embodiments of this application.

User information (including but not limited to user equipment information, personal user information, etc.) and data (including but not limited to data used for analysis, stored data, displayed data, etc.) in this application are information and data that are authorized by a user or that are fully authorized by each party. Furthermore, related data need to be collected, used, and processed in compliance with relevant laws, regulations and standards of relevant countries and regions, and corresponding operation entries are provided for the user to choose to authorize or reject.

1. A memory management method for an inference system, applied to an inference engine in the inference system, wherein a computing resource of the inference engine comprises a GPU loaded on a computing device on which the inference engine is deployed; the inference engine maintains a schedule queue used to schedule an inference request set; and the method comprises:
determining a memory management time window according to data processing duration associated with an inference request set being executed in the schedule queue;
computing a GPU memory demand amount corresponding to the inference request set in the memory management time window, and allocating a GPU memory to the inference request set according to the GPU memory demand amount; and
determining, when the memory management time window ends, a next memory management time window corresponding to the memory management time window again according to data processing duration associated with an inference request set being executed in the schedule queue.

2. The method according to claim 1, wherein determining a memory management time window according to data processing duration associated with an inference request set being executed in the schedule queue comprises:
determining that there is an inference request at a prefill stage in the inference request set being executed in the schedule queue;
upon determining that there is an inference request at the prefill stage, determining a maximum token quantity corresponding to the inference request in the inference request set, and determining the memory management time window according to token processing duration corresponding to the maximum token quantity;
determining that no inference request at the prefill stage exists in the inference request set being executed in the schedule queue; and
upon determining that no inference request at the prefill stage exists, determining longest token generation duration corresponding to an inference request in the inference request set, and determining the memory management time window according to the longest token generation duration.

3. The method according to claim 1, wherein computing a GPU memory demand amount corresponding to the inference request set in the memory management time window comprises:
computing static GPU memory usage corresponding to the inference request set in the memory management time window;
determining maximum GPU memory usage in a previous memory management time window corresponding to the memory management time window and a sum of static GPU memory usage corresponding to the inference request set in each target memory management time window, and determining a difference between the maximum GPU memory usage and the sum of the static GPU memory usage as dynamic GPU memory usage corresponding to the inference request set in the memory management time window, wherein the target memory management window is a memory management window located before the memory management time window in a process of executing the inference request set; and
determining a sum of the static GPU memory usage and the dynamic GPU memory usage as the GPU memory demand amount corresponding to the inference request set in the memory management time window.

4. The method according to claim 3, wherein computing static GPU memory usage corresponding to the inference request set in the memory management time window comprises:
determining that there is an inference request at a prefill stage in the inference request set being executed in the schedule queue;
upon determining that there is an inference request at the prefill stage, determining first GPU memory usage needed by a token corresponding to each inference request in the inference request set, generating, based on each inference request in the inference request set, second GPU memory usage needed by one token, and determining a sum of the first GPU memory usage and the second GPU memory usage as the static GPU memory usage corresponding to the inference request set in the memory management time window;
determining that no inference request at a prefill stage exists in the inference request set being executed in the schedule queue; and
upon determining that no inference request at the prefill stage exists, generating GPU memory usage needed by one token based on each inference request in the inference request set, and determining the GPU memory usage as the static GPU memory usage corresponding to the inference request set in the memory management time window.

5. The method according to claim 1, wherein allocating a GPU memory to the inference request set according to the GPU memory demand amount comprises:
obtaining current GPU memory usage corresponding to the inference request set;
determining, according to the current GPU memory usage and the GPU memory demand amount, that a GPU memory allocation condition or a GPU memory release condition is met;
upon determining that the GPU memory allocation condition is met, allocating a GPU memory to the inference request set according to the GPU memory demand amount; and
upon determining that the GPU memory release condition is met, releasing a GPU memory used to execute the inference request set, and updating the current CPU memory usage, to allocate a GPU memory to the inference request set according to the GPU memory demand amount if it is determined that the GPU memory allocation condition is met according to the updated current GPU memory usage and the GPU memory demand amount.

6. The method according to claim 5, wherein the GPU memory allocation condition comprises:
a sum of the current GPU memory usage and the GPU memory demand amount is less than a preset first threshold; and
the GPU memory release condition comprises:
the current GPU memory usage is greater than a preset second threshold.

7. The method according to claim 5, wherein releasing a GPU memory used to execute the inference request set comprises:
determining that a quantity of inference requests in the inference request set is greater than a preset third threshold;
upon determining that the quantity is greater than the preset third threshold, offloading a token corresponding to each inference request in the inference request set to a CPU memory, to release a GPU memory occupied by the token;
determining that the quantity of inference requests in the inference request set is not greater than the preset third threshold; and
upon determining that the quantity is not greater than the preset third threshold, updating the inference request based on the token corresponding to each inference request in the inference request set, to release a GPU memory occupied by the token.

8. A computing device comprising a memory and a processor, wherein the memory stores executable instructions that, in response to execution by the processor, causes the processor to perform a memory management method for an inference system, applied to an inference engine in the inference system, wherein a computing resource of the inference engine comprises a GPU loaded on the computing device on which the inference engine is deployed; the inference engine maintains a schedule queue used to schedule an inference request set; and the method comprises:
determining a memory management time window according to data processing duration associated with an inference request set being executed in the schedule queue;
computing a GPU memory demand amount corresponding to the inference request set in the memory management time window, and allocating a GPU memory to the inference request set according to the GPU memory demand amount; and
determining, when the memory management time window ends, a next memory management time window corresponding to the memory management time window again according to data processing duration associated with an inference request set being executed in the schedule queue.

9. The computing device according to claim 8, wherein determining a memory management time window according to data processing duration associated with an inference request set being executed in the schedule queue comprises:
determining that there is an inference request at a prefill stage in the inference request set being executed in the schedule queue;
upon determining that there is an inference request at the prefill stage, determining a maximum token quantity corresponding to the inference request in the inference request set, and determining the memory management time window according to token processing duration corresponding to the maximum token quantity;
determining that no inference request at the prefill stage exists in the inference request set being executed in the schedule queue; and
upon determining that no inference request at the prefill stage exists, determining longest token generation duration corresponding to an inference request in the inference request set, and determining the memory management time window according to the longest token generation duration.

10. The computing device according to claim 8, wherein computing a GPU memory demand amount corresponding to the inference request set in the memory management time window comprises:
computing static GPU memory usage corresponding to the inference request set in the memory management time window;
determining maximum GPU memory usage in a previous memory management time window corresponding to the memory management time window and a sum of static GPU memory usage corresponding to the inference request set in each target memory management time window, and determining a difference between the maximum GPU memory usage and the sum of the static GPU memory usage as dynamic GPU memory usage corresponding to the inference request set in the memory management time window, wherein the target memory management window is a memory management window located before the memory management time window in a process of executing the inference request set; and
determining a sum of the static GPU memory usage and the dynamic GPU memory usage as the GPU memory demand amount corresponding to the inference request set in the memory management time window.

11. The computing device according to claim 10, wherein computing static GPU memory usage corresponding to the inference request set in the memory management time window comprises:
determining that there is an inference request at a prefill stage in the inference request set being executed in the schedule queue;
upon determining that there is an inference request at the prefill stage, determining first GPU memory usage needed by a token corresponding to each inference request in the inference request set, generating, based on each inference request in the inference request set, second GPU memory usage needed by one token, and determining a sum of the first GPU memory usage and the second GPU memory usage as the static GPU memory usage corresponding to the inference request set in the memory management time window;
determining that no inference request at a prefill stage exists in the inference request set being executed in the schedule queue; and
upon determining that no inference request at the prefill stage exists, generating GPU memory usage needed by one token based on each inference request in the inference request set, and determining the GPU memory usage as the static GPU memory usage corresponding to the inference request set in the memory management time window.

12. The computing device according to claim 8, wherein allocating a GPU memory to the inference request set according to the GPU memory demand amount comprises:
obtaining current GPU memory usage corresponding to the inference request set;
determining, according to the current GPU memory usage and the GPU memory demand amount, that a GPU memory allocation condition or a GPU memory release condition is met;
upon determining that the GPU memory allocation condition is met, allocating a GPU memory to the inference request set according to the GPU memory demand amount; and
upon determining that the GPU memory release condition is met, releasing a GPU memory used to execute the inference request set, and updating the current CPU memory usage, to allocate a GPU memory to the inference request set according to the GPU memory demand amount if it is determined that the GPU memory allocation condition is met according to the updated current GPU memory usage and the GPU memory demand amount.

13. The computing device according to claim 12, wherein the GPU memory allocation condition comprises:
a sum of the current GPU memory usage and the GPU memory demand amount is less than a preset first threshold; and
the GPU memory release condition comprises:
the current GPU memory usage is greater than a preset second threshold.

14. The computing device according to claim 12, wherein releasing a GPU memory used to execute the inference request set comprises:
determining that a quantity of inference requests in the inference request set is greater than a preset third threshold;
upon determining that the quantity is greater than the preset third threshold, offloading a token corresponding to each inference request in the inference request set to a CPU memory, to release a GPU memory occupied by the token;
determining that the quantity of inference requests in the inference request set is not greater than the preset third threshold; and
upon determining that the quantity is not greater than the preset third threshold, updating the inference request based on the token corresponding to each inference request in the inference request set, to release a GPU memory occupied by the token.

15. A non-transitory computer-readable storage medium comprising instructions stored therein that, when executed by a processor of a computing device, causes the computing device to perform a memory management method for an inference system, applied to an inference engine in the inference system, wherein a computing resource of the inference engine comprises a GPU loaded on the computing device on which the inference engine is deployed; the inference engine maintains a schedule queue used to schedule an inference request set; and the method comprises:
determining a memory management time window according to data processing duration associated with an inference request set being executed in the schedule queue;
computing a GPU memory demand amount corresponding to the inference request set in the memory management time window, and allocating a GPU memory to the inference request set according to the GPU memory demand amount; and
determining, when the memory management time window ends, a next memory management time window corresponding to the memory management time window again according to data processing duration associated with an inference request set being executed in the schedule queue.

16. The non-transitory computer-readable storage medium according to claim 15, wherein determining a memory management time window according to data processing duration associated with an inference request set being executed in the schedule queue comprises:
determining that there is an inference request at a prefill stage in the inference request set being executed in the schedule queue;
upon determining that there is an inference request at the prefill stage, determining a maximum token quantity corresponding to the inference request in the inference request set, and determining the memory management time window according to token processing duration corresponding to the maximum token quantity;
determining that no inference request at the prefill stage exists in the inference request set being executed in the schedule queue; and
upon determining that no inference request at the prefill stage exists, determining longest token generation duration corresponding to an inference request in the inference request set, and determining the memory management time window according to the longest token generation duration.

17. The non-transitory computer-readable storage medium according to claim 15, wherein computing a GPU memory demand amount corresponding to the inference request set in the memory management time window comprises:
computing static GPU memory usage corresponding to the inference request set in the memory management time window;
determining maximum GPU memory usage in a previous memory management time window corresponding to the memory management time window and a sum of static GPU memory usage corresponding to the inference request set in each target memory management time window, and determining a difference between the maximum GPU memory usage and the sum of the static GPU memory usage as dynamic GPU memory usage corresponding to the inference request set in the memory management time window, wherein the target memory management window is a memory management window located before the memory management time window in a process of executing the inference request set; and
determining a sum of the static GPU memory usage and the dynamic GPU memory usage as the GPU memory demand amount corresponding to the inference request set in the memory management time window.

18. The non-transitory computer-readable storage medium according to claim 17, wherein computing static GPU memory usage corresponding to the inference request set in the memory management time window comprises:
determining that there is an inference request at a prefill stage in the inference request set being executed in the schedule queue;
upon determining that there is an inference request at the prefill stage, determining first GPU memory usage needed by a token corresponding to each inference request in the inference request set, generating, based on each inference request in the inference request set, second GPU memory usage needed by one token, and determining a sum of the first GPU memory usage and the second GPU memory usage as the static GPU memory usage corresponding to the inference request set in the memory management time window;
determining that no inference request at a prefill stage exists in the inference request set being executed in the schedule queue; and
upon determining that no inference request at the prefill stage exists, generating GPU memory usage needed by one token based on each inference request in the inference request set, and determining the GPU memory usage as the static GPU memory usage corresponding to the inference request set in the memory management time window.

19. The non-transitory computer-readable storage medium according to claim 15, wherein allocating a GPU memory to the inference request set according to the GPU memory demand amount comprises:
obtaining current GPU memory usage corresponding to the inference request set;
determining, according to the current GPU memory usage and the GPU memory demand amount, that a GPU memory allocation condition or a GPU memory release condition is met;
upon determining that the GPU memory allocation condition is met, allocating a GPU memory to the inference request set according to the GPU memory demand amount; and
upon determining that the GPU memory release condition is met, releasing a GPU memory used to execute the inference request set, and updating the current CPU memory usage, to allocate a GPU memory to the inference request set according to the GPU memory demand amount if it is determined that the GPU memory allocation condition is met according to the updated current GPU memory usage and the GPU memory demand amount.

20. The non-transitory computer-readable storage medium according to claim 19, wherein the GPU memory allocation condition comprises:
a sum of the current GPU memory usage and the GPU memory demand amount is less than a preset first threshold; and
the GPU memory release condition comprises:
the current GPU memory usage is greater than a preset second threshold.
